(19) United States
(12) Patent Application Publication
(10) Pub. No.: US 2009/0056855 A1
(43) Pub. Date: Mar. 5, 2009

(54) LAMINATOR, PRESSURE MEMBRANE, AND METHOD FOR LAMINATING COMPONENT STACKS

(76) Inventor: Hans-Gerd Stevens, Bocholt (DE)

Correspondence Address: GREER, BURNS & CRAIN, LTD., Suite 2500, 300 South Wacker Drive, Chicago, IL, 60606, US

(21) Appl. No.: 12/199,353

(22) Filed: Aug. 27, 2008

(30) Foreign Application Priority Data
Aug. 30, 2007 (DE) DE 102007041261.6

(51) Int. Cl. B32B 37/10; B32B 37/06

(52) U.S. Cl. 156/64; 156/381; 156/378; 156/379.6; 156/308.2

(57) ABSTRACT

A pressure membrane, a method and a laminator for laminating components, in particular solar cell modules or laminated glass plates, through the combined application of pressure and heat. The laminator includes at least one laminating chamber that accommodates one or more component stacks, the chamber having a component support and at least one heating device. Each heating device is made up of at least one heating element. At least one elastic and/or flexible pressure membrane is clamped in pressure-tight fashion in the chamber above the component support and is movable relative thereto. The pressure membrane divides a lower chamber part from an upper chamber part. At least the lower chamber part is capable of being sealed in airtight fashion and is capable of being evacuated and ventilated. The at least one heating element is provided integrally with the pressure membrane.

### BACKGROUND OF THE INVENTION

The present invention relates to a laminator for laminating component stacks, in particular solar cell modules or laminated or safety glass plates or panes, using the combined application of heat and pressure, the laminator comprising at least one laminating chamber that accommodates one or more component stacks, having a component support and a heating device. In the chamber, a flexible pressure membrane is clamped in pressure-tight fashion above the component support and movable relative thereto, said pressure membrane dividing a lower chamber part from an upper chamber part, and at least the lower chamber part with the component stack being capable of being sealed in airtight fashion, and also being capable of being evacuated and of being ventilated, and the heat required for the lamination being supplied to the component stack by at least one heating element of a heating device. In addition, the present invention relates to a pressure membrane and to a method for laminating component stacks.

A laminator of the type named above is known for example from WO 94/29106 A1. Such a laminator is made up essentially of one or more membrane compression molding machines with which the individual parts of the component stack that are to be laminated are pressed against one another, and of at least one heating device with which the heat required to bond the individual parts is introduced into the components. The pressure required for the laminating process is applied to the component stack via a pressure membrane made of an elastic, flexible material, e.g. silicon rubber. The pressure membrane divides, in pressure-tight fashion, the interior space of a laminating chamber that is capable of being sealed in airtight fashion into a lower chamber part in which a component support and the component stack are situated and an upper chamber part situated above the pressure membrane. The required pressure of the pressure membrane is produced by a pressure gradient between the two chamber parts, such that the higher pressure in the upper chamber part oriented away from the component stack presses the membrane onto the component stack. Standardly, for this purpose a partial vacuum is produced in the lower chamber part, while the upper chamber part is ventilated with atmospheric pressure, or can be provided with an excess pressure for support.

The heat required for the bonding of the individual parts is standardly introduced into the component stack by a heating device made up of electrical heating elements or of conduits for transporting a heat transmission agent. In practice, the heating device is usually integrated into the component support. However, the layers of the component stack that are to be bonded are often situated closer to the surface of the laminated component than to the support surface. Therefore, in a laminator of the type named above a relatively large quantity of energy and a relatively long time are required for heating and for subsequent cooling, due to the larger distance between the contact surface of the heating device and the layer to be laminated. In addition, the large mass that is to be heated and cooled reacts relatively slowly to the changes in temperature, which makes it difficult to optimize the process management so as to achieve economical cycle times with a simultaneously low reject rate.

DE 41 12 607 A1 therefore proposes a system in which the heat is transmitted through the membrane onto the layer close to the surface of the component stack that is to be heated. Here, the heating device is made up of a flexible heating mat that is situated in the upper chamber part, above the pressure membrane, and also lies loosely on the membrane when the membrane is pressing against the stack. However, this can result in a poor transfer of heat at edge regions of the components that are to be laminated, or given more complex surface shapes.

In contrast, WO 98/38033 A1 indicates a multifunctional membrane press in which, in additional to the usual heating device, the pressure membrane can be brought at its surface into contact with a rigid heating plate, after which the pressure membrane is then pressed onto the component stack. However, for this purpose the laminator requires an additional lifting device in order to guide the upper heating plate. Moreover, the energy and time requirement is significant due to the additional required method steps and the temporary suspension, at times, of the contact between the heating device and the pressure membrane. In addition, the rigid upper heating plate must form the exact negative shape of the surface formed by the pressure membrane when this membrane is pressed against the surface of the component stack.

### SUMMARY OF THE INVENTION

The object of the present invention is therefore to create a laminator of the type named above, a pressure membrane therefor, and a method for laminating component stacks that avoid the above-described disadvantages during the heating of the component stack, and with which in particular an economical manufacturing is ensured through shortening of the cycle times, reduction of energy consumption, and avoidance of rejection due to improved process management.

The solution of the part of this object relating to the laminator is achieved according to the present invention by a laminator of the type named above in which at least one heating element for heating the component stack is fashioned integrally with the pressure membrane.

A laminator having a heatable pressure membrane that is provided at least in some areas with an integral heating element offers the advantage that the heat is produced by the laminator directly in the immediate vicinity of the point at which it is actually required, namely underneath the pressure membrane, in the layers close to the surface that are to be laminated of the component stack. The heat path is thus very short, so that thermal losses on this path are very low. In this way, a heating of the layers to be laminated can take place significantly faster and more effectively. Thus, a heating of the component stack from the component support is no longer necessary, or serves only to maintain a certain basic quantity of heat, for example in order to keep the temperature difference with the machine bed as low as possible and to prevent a rapid flow of the heat into the lower layers of the component stack or into a colder component support.

For the lamination of component stacks having a small component thickness, it may even be advantageous not to heat the component support at all, but rather to fashion the component support from the machine bed as a heat-insulated support surface. In this way, the required heat input becomes even lower, because only the component stack and the pressure membrane have to be heated. The corresponding cycle times can thus be further shortened.

A cooling phase required for the change of cycle can accordingly be made shorter, because a larger mass of the component stack underneath the layers to be laminated need not be heated to a higher temperature in order to achieve the required lamination temperature; rather, this mass need be brought only to a temperature that ensures a uniform temperature on both sides of the layers to be laminated. This also reduces the danger of overheating, thus helping to prevent rejects.

Another significant advantage is that due to the lower masses to be heated and cooled cyclically, a less sluggish and therefore more precise temperature controlling is possible, contributing to a more reliable process management. This results in an increase in the quality rate, despite the shortening of the cycle times.

A pressure membrane of the type according to the present invention is easily exchangeable, so that down time for membrane exchange in the production chain is kept short. At the same time, it is very advantageous that a pressure membrane of the type according to the present invention can also be retrofitted in existing laminators or other compression molding machines, such as those known for example from furniture manufacturing.

In particular, a pressure membrane having an electrical resistance heating element is easily retrofitted in existing laminators, because the essential components of the heating device are integrated into the pressure membrane, and the electrical connection lines can easily be led out from the laminator in pressure-tight fashion. If the upper chamber part is constructed without a cover, i.e. is ventilated only with atmospheric pressure, retrofitting with a heatable pressure membrane is very easy. Greater expense is required only for the adaptation of the process controlling to the changed process conditions of the heat transfer, and to the shortened cycle times.

The solution of the part of the object relating to the method for laminating component stacks is achieved according to the present invention by a method in which each of the component stacks to be laminated is supplied with heat at its side oriented toward the pressure membrane, the heat being produced by at least one heating element that is fashioned integrally with the pressure membrane.

Here it is particularly advantageous to supply the heat only from the side of the component stack oriented toward the pressure membrane, because the layers that are to be laminated are for the most part situated not in the center of a component stack, but rather closer to one surface. The quantity of heat to be introduced can then be lower from this side oriented toward the pressure membrane, and can be further reduced if a flow of heat from the component stack to the side oriented away from the membrane is prevented, or at least significantly reduced, by thermal insulation, for example of the component support.

For the pressure membrane, it is for example provided that the heating element be cast, glued, or vulcanized into the pressure membrane. This has the advantage that the membrane simultaneously ensures the mechanical and electrical protection of the heating lines. However, in the case of thin pressure membranes it is also possible to glue a heating element onto the membrane surface or to vulcanize it onto the surface. A combination of heating elements realized in the membrane and on the membrane, in a laminator or also in a pressure membrane, is also conceivable.

During the pressing process, a pressure membrane is subjected to elastic and/or flexible deformation as a function of its surface shape and the thickness of the component stack being laminated. A heating element fashioned integrally with the pressure membrane must of course be fashioned in such a way that it can participate in or accept the elastic and/or flexible deformation. For this purpose, it is provided to route the heating lines in a suitably meander-shaped fashion or helical fashion or spiral fashion, or in some combination thereof, the main directions of expansion of the membrane being the determining factors for the geometry of the routing of the heating lines.

In addition, for a stronger mechanical loading capacity of the heating lines, these lines can be suitably formed by making them for example tube-shaped or helical in the direction of their longitudinal extension. In addition to a high degree of flexibility, this also results in a high capacity for accepting elastic deformations, for example in the form of expansions and the resulting transverse compressions. Elastic and/or flexible heating lines made in this way can also be routed in a straight line or in a zigzag pattern.

For embodiments in which a necessary deformation of the pressure membrane is greater than the deformability of the heating element that can be achieved using the features described above, it is provided to limit the deformation of the membrane at least in the area of the heating element by a suitable construction, and/or through additional means. Here, the pressure membrane is constructed with a less elastic and/or less flexible core area, and a more elastic and/or more flexible edge area. The more rigid core area is then at least as large as the area of the pressure membrane that can be heated by the integral heating elements.

A rigidification of the core area can most easily be achieved by providing the pressure membrane with a greater material thickness, at least in the area of the heating element, than in the rest of the membrane. Here, the thickness of the material of the membrane preferably decreases continuously in the transition zone from the edge of the heating element to the rest of the membrane. However, a multilayered construction of the pressure membrane in the area of the heating elements is also conceivable.

In another specific embodiment, additional means for limiting deformation are provided in or on the membrane at least over the surface of the heatable area of the pressure membrane. These means can for example be realized as plates, films, meshes, rods or bars, or the like situated in or on the membrane. The required deformation and expansion of the membrane is in this way displaced to the more elastic and/or more flexible edge area of the membrane. If these additional means are made of a material having a good heat conductivity, there results the additional advantage of uniform and rapid heat distribution in the surface of the pressure membrane. The number of heat conductors can therefore be limited to those that are necessary from a thermotechnical point of view, and need not be adapted to the requirements of uniform heat distribution.

Overall, the additional means not only reduce the mechanical loading of the heating lines of the heating element; rather, above all the mechanical connection between the heating line and the membrane material is relieved of stress, which has a positive effect on the useful life of the pressure membrane according to the present invention.

The heating element, fashioned integrally with the pressure membrane, can be realized as an electrical resistance heater, either as a surface resistance heater or as a wire resistance heater; the heating layers can then be connected to the membrane preferably in helical, spiral, or meander fashion.

An embodiment is also conceivable having a heating element that is excited via induction or via an eddy current; in this case the heating conductors of the heating element are preferably realized as surface elements, such as films, or can be embedded in the surface of the membrane as particles, or can be attached on the membrane. For this purpose, the membrane can be for example doped in some areas with inductively active particles. Such a pressure membrane then has the additional advantage of contactless energy transmission for the production of heat, which facilitates rapid exchange of the membrane in case of damage.

In another embodiment, the heating of the pressure membrane can be provided by a suitable fluid heat-transmitting agent that is transported through conduits that are formed in the pressure membrane and/or are integrally formed on or attached to the pressure membrane. In the case of conduits formed in the membrane, it is particularly advantageous if these are made of a material having an elasticity or flexibility similar to that of the pressure membrane itself, such as for example silicon hoses.

In such conduits, it is also conceivable to introduce an electrical resistance heating line instead of the heat-transmitting fluid stream. In this case, the heating line is then, like the fluid stream, not connected fixedly to the pressure membrane, but the walls of the conduits are in both cases fashioned immediately integrally with the pressure membrane, just as the heating lines of the previously described exemplary embodiments were fashioned immediately integrally with the pressure membrane. Due to the fact that a heating line incorporated in such a conduit is locally bound to the corresponding conduit just as a fluid stream is, such a heating element is at least mediately fashioned integrally with the pressure membrane. Here, the mechanical loading of the pressure membrane during the pressure process is transmitted not directly to the heating line, but rather acts mainly on the walls of the conduits. For this purpose, the heating lines are preferably introduced into the conduit with a small amount of play.

The durability and useful life of the pressure membrane and of the heating elements can be significantly increased in this way. In addition, such a pressure membrane provided with conduits has the advantage that in the case of a defect the heating lines can easily be exchanged even given an installed membrane. If the membrane as a whole has to be exchanged, the heating line can be removed from the defective membrane without destroying it and can be used again. Thus, the significant advantage is also provided of simple material separation during the disposal of used pressure membranes.

The temperature sensors required for the controlling of the heating elements can advantageously be integrated into the pressure membrane, like the heating element itself, or can be integrally connected to the pressure membrane. The recording of the measurement values takes place in immediate proximity to the temperature to be measured for the layer being laminated, the sensor being simultaneously mechanically and electrically protected by the membrane. Here, spare sensors can also be integrated that can be selectively activated in case of failure of a sensor. This makes sense because the costs of a sensor are insignificant compared to the cost of down time of a laminator, or the cost of exchanging a membrane.

Also conceivable is an advantageous situation of temperature sensors outside the heating elements that are connected integrally to the pressure membrane, e.g. on the surface of the component support, underneath the component stack. Monitoring of these temperatures enables an improved and more reliable influencing of the process management.

It is also easily possible to use the pressure membrane according to the present invention in the known laminators having a double membrane. Retrofitting by replacing one or both membranes with one or two heatable membranes of the type named above can also be carried out. In a possible specific embodiment having two heatable membranes, the heating level of both membranes can also be optionally switched together, enabling further process optimization. It is also possible to fashion the pressure membrane as a multiple membrane having three or more membranes.

In addition, it is conceivable to install a heatable third membrane between two non-heatable membranes of a double membrane, at least one heating element being connected integrally to said third membrane. The intermediate space between the two membranes of the double membrane is here evacuated in a known manner at least for the duration of the pressure process, so that the two non-heatable membranes of the double membrane, and the heatable membrane situated in the intermediate space, together form the pressure membrane.

An advantageous further construction of the laminator provides that a device for measuring the pressure in the intermediate space be connected to the intermediate space between each two adjacent membranes of the pressure membrane. Via this pressure measurement device, information about the state of the pressure membrane can be obtained easily and reliably.

In a further construction, a pressure indicator device that can be read by the operator of the laminator can be connected subsequent to the device for measuring the pressure in the intermediate space. Damage to the pressure membrane that are expressed as changes in pressure in the intermediate space can then be recognized immediately, and the necessary measures can be introduced or planned.

Alternatively, or in addition, an evaluation unit can be connected subsequent to the device for measuring the pressure in the intermediate space, said evaluation unit triggering an alarm upon the occurrence of a pressure in the intermediate space that falls above or below a specifiable boundary value. In this embodiment, the operator has less of a burden, because here the evaluation unit takes over the job of determining the occurrence of damage and signaling it as an alarm.

With the device for measuring the pressure in the intermediate space, in its various embodiments, the possibility is created of reliably determining loss of tightness of one of the membranes, in particular the membrane that comes into contact with the component and is thus subject to particular stress. As already explained above, the operation of the laminator can at first continue even if a loss of tightness has been detected within the multilayer pressure membrane (for example, a loss of tightness of the membrane coming into contact with the component), because at least one additional membrane inside the multilayer pressure membrane still provides the required tightness of the pressure membrane as a whole. Care must merely be taken to exchange the non-tight membrane for a new one at the next opportunity, in particular the next regular maintenance of the laminator. The device for measuring the pressure in the intermediate space provides an early recognition of loss of tightness of the membrane before this can be recognized visually by the operator of the laminator. This ensures a particularly reliable operation of the laminator, thus significantly reducing the reject rate.

### BRIEF DESCRIPTION OF THE DRAWINGS

In the following, exemplary embodiments of the present invention are explained on the basis of a drawing.

FIG. 1 shows a laminator or compression molding machine in a cross-section,

FIG. 2 shows a heatable pressure membrane in an isometric representation,

FIG. 3 shows a heatable pressure membrane in an isometric representation having a plurality of heating elements and deformation limiting,

FIG. 4 shows a corresponding pressure membrane in cross-section,

FIG. 5 shows a pressure membrane having thicker material in the area of the heating element, in cross-section,

FIG. 6 shows a pressure membrane having a heating element fashioned integrally on its surface,

FIG. 7 shows a pressure membrane having a plurality of heating elements on its surface, situated one over the other,

FIG. 8 shows two pressure membranes, one pressure membrane being fashioned with an integral heating element,

FIG. 9 shows two non-heatable pressure membranes having one heatable membrane situated between them, and

FIG. 10 shows a laminator or compression molding machine having an insulated component support.

### DETAILED DESCRIPTION OF THE PREFERRED EMBODIMENTS

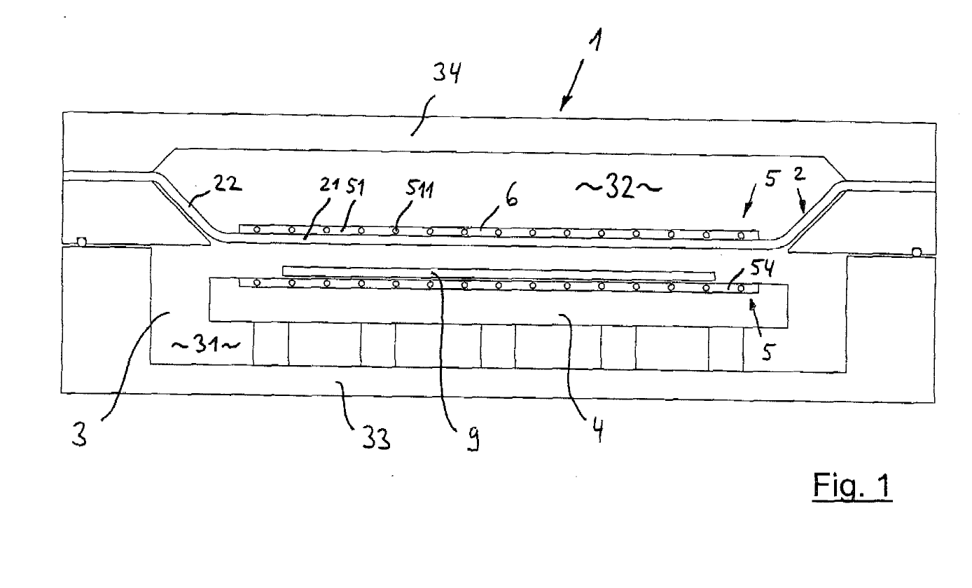

As FIG. 1 shows, laminator 1 has a lamination chamber 3 that is divided in pressure-tight fashion by a pressure membrane 2 into a lower chamber part 31 and an upper chamber part 32. In lower chamber part 31 there is situated a component support 4 on which there is situated a component stack 9 for the laminating process.

Lower chamber part 31 is limited in pressure-tight fashion by chamber housing 33 on the one hand and by pressure membrane 2 on the other hand, so that component stack 9 is situated in lower chamber part 31, underneath pressure membrane 2. For the pressing process, lower chamber part 31 is provided with a partial vacuum, or is almost completely evacuated. The pressure gradient between lower chamber part 31 underneath pressure membrane 2 and upper chamber part 32 above pressure membrane 2 presses membrane 2 downward onto the surface of component stack 9 and component support 4. Here the pressure in upper chamber part 32 can correspond to atmospheric pressure, so that a pressure-tight upper chamber housing 34 is not required. For better regulation of the pressure force, the air pressure in upper chamber part 32 can be variably set during the pressure process, from a slight partial vacuum to a slight excess pressure, by making upper chamber part 32, formed by upper chamber housing 34 and pressure membrane 2, capable of being sealed in airtight fashion, and by enabling both chamber parts 31, 32 to be evacuated and/or ventilated during a manufacturing cycle.

The heat required for the bonding of the layers that are to be laminated is produced in at least one heating device 5 and is supplied to component stack 9 via at least one heating element 51. In this exemplary embodiment, heating element 51 is glued or vulcanized onto pressure membrane 2 on its side oriented away from component stack 9. An additional heating element 54 is situated on component support 4 in a standard manner, but here need not conduct the entire quantity of heat for the laminating process through component stack 9 from underneath to the layer to be laminated; rather, said element is required only to control the temperatures desired during the individual process steps at the underside of component stack 9. These temperatures may also be lower than the temperatures brought in from the upper side of component stack 9.

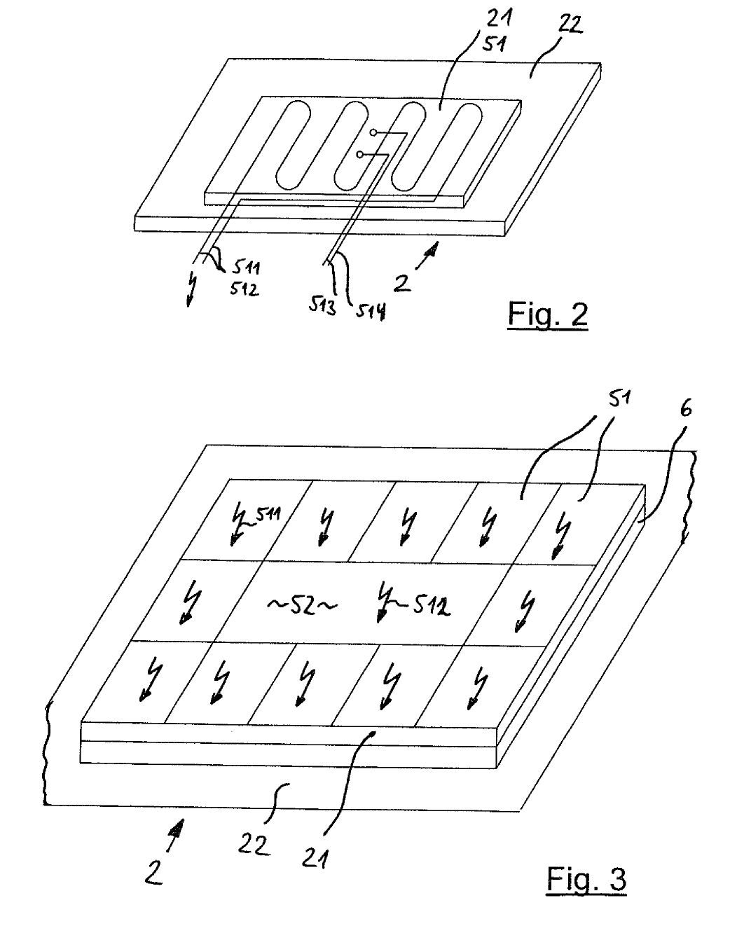

As can be seen in FIG. 2, heatable pressure membrane 2 is made up of a heatable core area 21 and an edge area 22 between the core area and the clamping of the pressure membrane to chamber housing 33, 34. The eatable region of pressure membrane 2 is formed by a heating element 51 that is connected integrally to the membrane, heating element 51 being cast or glued into pressure membrane 2. In the heating element, which is connected integrally to pressure membrane 2, heating lines 511 are present that are routed in a manner suitable to accept the deformations that occur in the membrane during the pressure process.

In addition, for a stronger mechanical loading capacity of heating lines 511, these can be suitably fashioned by making them for example tube-shaped or helical in the direction of their longitudinal extension.

FIG. 3 shows an exemplary embodiment of a pressure membrane 2 having a plurality of heating elements 51, 52 that are distributed over the heating surface and that can preferably be controlled individually or in groups. For this purpose, at least one temperature sensor 513 is provided in or on heating elements 51, 52, said sensor or sensors preferably also being fashioned integrally with pressure membrane 2. An additional temperature sensor 514, which can be activated in case of damage to first sensor 513, avoids the necessity of changing an entire pressure membrane 2 in case of such a defect.

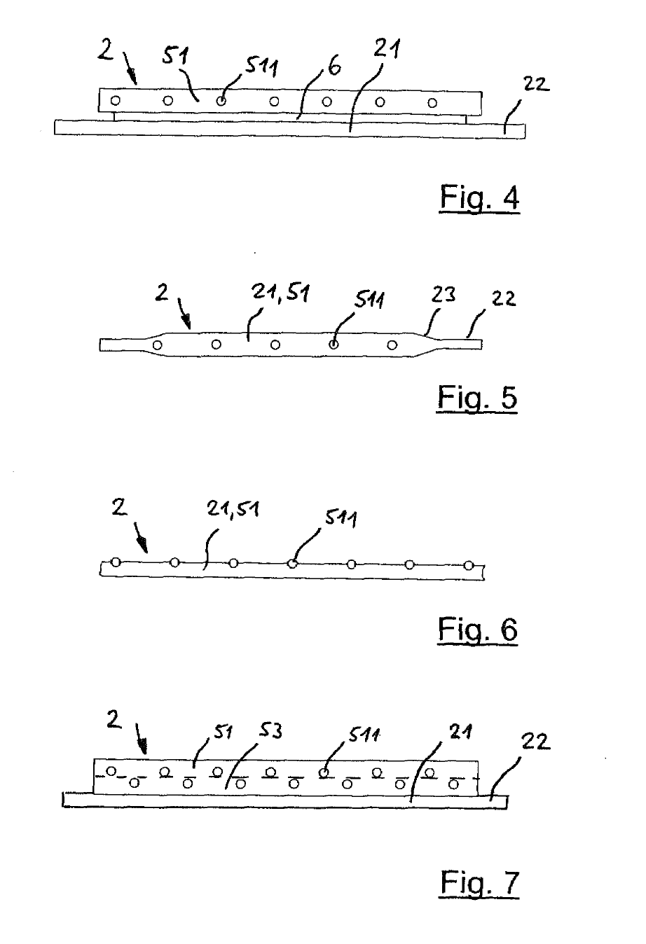

Below heating elements 51 there is attached a thin plate or film 6 for the limitation of the elastic and/or flexible deformation of pressure membrane 2. The elastic and/or flexible deformation required for the pressure process is here displaced to edge area 22, which is more capable of expansion, of pressure membrane 2; in the heatable area, the flexibility is only as great as required by the characteristics of component stack 9. FIG. 4 shows such a membrane in a cross-section.

FIG. 5 shows a pressure membrane 2 in which the limitation of the deformation for heatable area 21 relative to expandable area 22 is achieved by a thickening of the material of pressure membrane 2, the thickness of the material increasing continuously in transition zone 23.

FIG. 6 shows a particularly economical heatable pressure membrane 2 in which heating element 51 in heatable area 21 is formed by glued-on or vulcanized-on heating lines 511.

FIG. 7 shows an arrangement of a pressure membrane 2 having a plurality of heating elements situated one over the other, which can also be controlled individually or in groups.

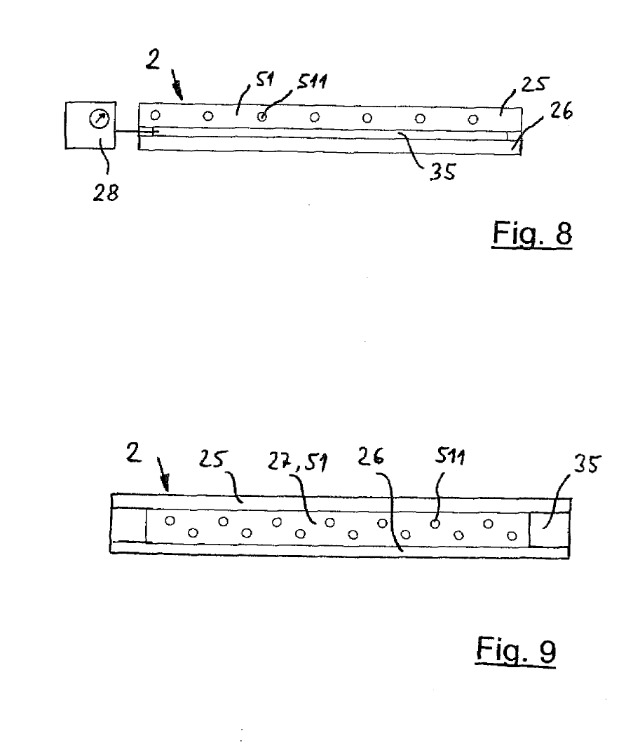

FIG. 8 shows an exemplary embodiment of a laminator having a double membrane in the form of two pressure membranes 25 and 26, of which one is fashioned with an integral heating element 51.

The embodiment according to FIG. 8 provides that a device 28 for measuring the pressure in intermediate space 35 is connected to intermediate space 35 between the two adjacent membranes 25 and 26 of pressure membrane 2. Pressure measurements carried out using this pressure measurement device 28 can provide information concerning the tightness of pressure membrane 2. A pressure indicator device that can be read by operators of the laminator is allocated to pressure measurement device 28. Alternatively, or in addition, an evaluation unit can be allocated to pressure measurement device 28, said evaluation unit being capable of triggering an alarm upon the occurrence of a pressure in intermediate space 35 that falls above or below a specifiable boundary value.

FIG. 9 shows a double membrane made up of two standard non-heatable pressure membranes 25, 26. Here, heating element 51, in the form of an additional membrane 27, is placed loosely in intermediate space 35 between pressure membranes 25, 26. Intermediate space 35 with heatable membrane 27 is permanently evacuated, or is evacuated at least for the duration of the pressure process, so that the two pressure membranes 25, 26 press tightly against one another, integrally forming a common pressure membrane 2 together with pressed-in heatable membrane 27. This solution is particularly suitable for retrofitting existing laminators.

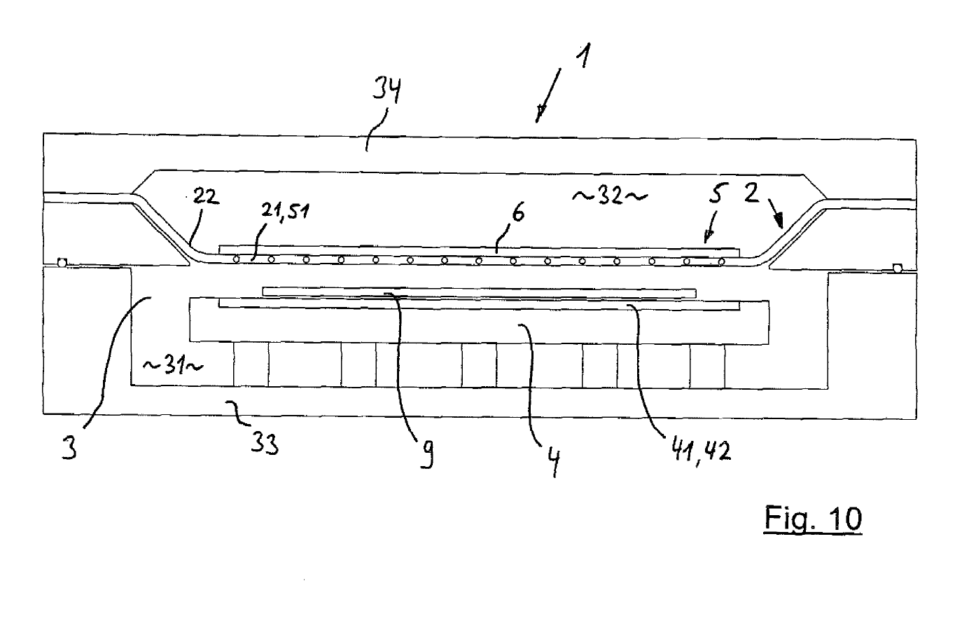

FIG. 10 shows an exemplary embodiment of a laminator 1 in which the heat for laminating component stack 9 is supplied to component stack 9 only from pressure membrane 2. Component support 4 on the underside of component stack 9 is provided with an insulating support 41, so that no heat flow, or only a slight heat flow, takes place from component stack 9 into component support 4.

Instead of insulating support 41, a heating element 42 can also be used that makes it possible not only to measure the temperature at the underside of component stack 9, but also to actively lower or increase this temperature according to the requirements of the process sequence.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A laminator for laminating components through the combined application of pressure and heat, the laminator comprising:
at least one laminating chamber that accommodates one or more component stacks,
said chamber having a component support and at least one heating device,
each such heating device being made up of at least one heating element,
at least one elastic and/or flexible pressure membrane being clamped in pressure-tight fashion in the chamber above the component support and movable relative thereto,
said pressure membrane dividing a lower chamber part from an upper chamber part,
at least the lower chamber part being capable of being sealed in airtight fashion and being capable of being evacuated and ventilated, and
the at least one heating element being fashioned integrally with the pressure membrane.

2. The laminator as recited in claim 1, wherein, in order to accommodate an elastic and/or flexible deformation of the pressure membrane, the at least one heating element is itself fashioned so as to be sufficiently elastic and/or flexible.

3. The laminator as recited in claim 1, wherein, in order to accommodate an elastic and/or flexible deformation of the pressure membrane, the at least one heating element forms an elastic and/or flexible arrangement with the pressure membrane.

4. The laminator as recited in claim 1, wherein for the pressure membrane, means for limiting the elastic and/or flexible deformation of the pressure membrane are provided at least in the area of the at least one integral heating element.

5. The laminator as recited in claim 1, wherein the pressure membrane has, at least in the area of its integral heating element, a material thickness that is greater than in the rest of the membrane.

6. The laminator as recited in claim 5, wherein the thickness of the material of the pressure membrane continuously decreases in the transition zone from an edge of the integral heating element to the rest of the membrane.

7. The laminator as recited in claim 4, wherein the means for limiting the elastic and/or flexible deformation of the pressure membrane are fashioned as additional flat or mesh-type or rod-shaped components in and/or on the pressure membrane.

8. The laminator as recited in claim 1, wherein heating lines of the heating elements are routed in helical fashion or in spiral fashion or in meander fashion on the membrane surface.

9. The laminator as recited in claim 8, wherein the heating lines are fashioned so as to be helical in the direction of their longitudinal extension.

10. The laminator as recited in claim 8, wherein the heating lines are fashioned so as to be tube-shaped in the direction of their longitudinal extension.

11. The laminator as recited in claim 1, wherein a plurality of heating elements are fashioned integrally with the pressure membrane, distributed over the membrane surface.

12. The laminator as recited in claim 11, wherein the plurality of heating elements are fashioned integrally with the pressure membrane, distributed in a plurality of layers over the membrane surface.

13. The laminator as recited in claim 1, wherein a plurality of heating elements fashioned integrally with the pressure membrane are capable of being controlled individually or in groups.

14. The laminator as recited in claim 1, wherein, in order to control the heating elements, at least one temperature sensor is allocated to each of the heating elements.

15. The laminator as recited in claim 14, wherein at least one spare sensor, which can be selectively set into operation, is allocated to each of the heating elements.

16. The laminator as recited in claim 14, wherein the temperature sensor is also attached integrally with the pressure membrane.

17. The laminator as recited in claim 14, wherein the temperature sensor is situated in the immediate vicinity of the side of the component stack oriented away from the pressure membrane.

18. The laminator as recited in claim 1, wherein the component support is fashioned so as to be thermally insulated from the component stack.

19. The laminator as recited in claim 1, wherein the heating element is cast, glued, or vulcanized into the pressure membrane and/or is glued or vulcanized onto the pressure membrane.

20. The laminator as recited in claim 1, wherein the heating element is fashioned in the form of heating lines routed loosely inside conduits formed or made in the pressure membrane.

21. The laminator as recited in claim 1, wherein a plurality of heating elements are fashioned integrally with the pressure membrane, with the same or different manner of connection.

22. The laminator as recited in claim 1, wherein the heating element is fashioned as an electrical resistance heating element.

23. The laminator as recited in claim 1, wherein the heating element is fashioned as a system that is heatable by induction or by an eddy current.

24. The laminator as recited in claim 1, wherein the heating element is fashioned as a conduit system for a fluid heat transport agent.

25. The laminator as recited in claim 1, wherein a plurality of heating elements having the same or different manner of functioning are fashioned integrally with the pressure membrane.

26. The laminator as recited in claim 1, wherein the pressure membrane is fashioned as a double membrane having two membranes situated one over the other, or as a multiple membrane having more than two membranes situated one over the other, at least one of the membranes situated one over the other integrally incorporating the at least one heating element.

27. The laminator as recited in claim 26, wherein the membranes situated one over the other are fashioned identically to one another.

28. The laminator as recited in claim 26, wherein an intermediate space between two adjacent membranes is connected to a device for evacuating and/or ventilating the intermediate space.

29. The laminator as recited in claim 26, wherein an intermediate space between two respectively adjacent membranes of the pressure membrane is connected to a device for measuring the pressure in the intermediate space.

30. The laminator as recited in claim 29, wherein a pressure indicator device that can be read by operators of the laminator is allocated to the device for measuring the pressure in the intermediate space.

31. The laminator as recited in claim 29, wherein an evaluation unit is allocated to the device for measuring the pressure in the intermediate space, said evaluation unit being capable of triggering an alarm upon the occurrence of a pressure in the intermediate space that falls above or below a specifiable boundary value.

32. The laminator as recited in claim 1, wherein two membranes are provided that do not have heating elements, and wherein in an intermediate space between the two membranes there is situated a membrane that is capable of being heated by the at least one integral heating element, and wherein at least during the pressure process the intermediate space between the membranes is evacuated, the three membranes together forming the pressure membrane.

33. A flexible pressure membrane for the lamination or joining of components through the combined application of pressure and heat the flexible pressure membrane being used to divide, in pressure-tight fashion, a chamber in a laminator into a lower chamber part and an upper chamber part comprising:
at least one heating element being fashioned integrally with the pressure membrane.

34. The flexible pressure membrane as recited in claim 33, wherein the at least one heating element is fashioned so as to be itself sufficiently elastic and/or flexible to accommodate an elastic and/or flexible deformation of the pressure membrane.

35. The flexible pressure membrane as recited in claim 33, wherein the at least one heating element forms an elastic and/or flexible arrangement with the pressure membrane in order to accommodate an elastic and/or flexible deformation of the pressure membrane.

36. The flexible pressure membrane as recited in claim 33, wherein at least in the area of the at least one integral heating element means are provided for the limitation of the elastic and/or flexible deformation of the pressure membrane.

37. The flexible pressure membrane as recited in claim 33, wherein at least in the area of its integral heating element, the pressure membrane has a material thickness that is greater than in the rest of the membrane.

38. The flexible pressure membrane as recited in claim 37, wherein the material thickness of the pressure membrane decreases continuously in the transition zone from the edge of the integral heating element to the rest of the membrane.

39. The flexible pressure membrane as recited in claim 36, wherein the means for limiting the elastic and/or flexible deformation of the pressure membrane are fashioned as additional flat or mesh-shaped or rod-shaped components in and/or on the pressure membrane.

40. The flexible pressure membrane as recited in claim 33, wherein heating lines of the heating element are routed in helical form or in spiral form or in meander form relative to the membrane surface.

41. The flexible pressure membrane as recited in claim 33, wherein heating lines of the heating element are fashioned so as to be helical in the direction of their longitudinal extension.

42. The flexible pressure membrane as recited in claim 33, wherein heating lines of the heating elements are fashioned so as to be tube-shaped in the direction of their longitudinal extension.

43. The flexible pressure membrane as recited in claim 33, wherein a plurality of heating elements are fashioned integrally with the pressure membrane distributed over the membrane surface.

44. The flexible pressure membrane as recited in claim 33, wherein a plurality of heating elements are fashioned integrally with the pressure membrane, distributed in a plurality of layers of the membrane surface.

45. The flexible pressure membrane as recited in claim 33, wherein a plurality of heating elements fashioned integrally with the pressure membrane are capable of being controlled individually or in groups.

46. The flexible pressure membrane as recited in claim 33, wherein at least one temperature sensor is allocated to each heating element in order to control the heating element.

47. The flexible pressure membrane as recited in claim 46, wherein at least one spare sensor that can be selectively be set into operation is allocated to each heating element.

48. The flexible pressure membrane as recited in claim 46, wherein the temperature sensor is also fashioned integrally with the pressure membrane.

49. The flexible pressure membrane as recited in claim 46, wherein the temperature sensor is capable of being attached spatially separate from the pressure membrane.

50. The flexible pressure membrane as recited in claim 33, wherein the heating element is cast, glued, or vulcanized into the pressure membrane, and/or is glued or vulcanized onto the pressure membrane.

51. The flexible pressure membrane as recited in claim 33, wherein the heating element is fashioned in the form of heating lines that are routed loosely inside conduits that are formed or made in the pressure membrane.

52. The flexible pressure membrane as recited in claim 33, wherein a plurality of heating elements are fashioned integrally with the pressure membrane with the same or different manner of connection.

53. The flexible pressure membrane as recited in claim 33, wherein the heating element is fashioned as an electrical resistance heating unit.

54. The flexible pressure membrane as recited in claim 33, wherein the heating element is fashioned as an arrangement that is capable of being heated through induction or by an eddy current.

55. The flexible pressure membrane as recited in claim 33, wherein the heating element is fashioned as a conduit system for a fluid heat transport agent.

56. The flexible pressure membrane as recited in claim 33, wherein a plurality of heating elements having the same or different manner of functioning are fashioned integrally with the pressure membrane.

57. A method for laminating component stacks in a laminator through the combined application of pressure and heat, the laminator comprising at least one lamination chamber that accommodates one or more component stacks, said chamber having a component support and at least one heating device, each such heating device being made up of at least one heating element, at least one elastic and/or flexible pressure membrane being clamped in pressure-tight fashion in the chamber above the component support and capable of movement relative thereto, said membrane dividing a lower chamber part from an upper chamber part, and at least the lower chamber part being capable of being sealed in airtight fashion and being capable of being evacuated and ventilated, comprising the steps of:
supplying heat to each component stack that is to be laminated at its side oriented toward the pressure membrane, and
producing the supplied heat by means of at least one heating element that is fashioned integrally with the pressure membrane.

58. The method as recited in claim 57, further including the step of additionally supplying heat to each component stack that is to be laminated at its side oriented away from the pressure membrane.

59. The method as recited in claim 57, further including the step of preventing or reducing a flow of heat from the component stack at its side oriented away from the pressure membrane by thermally insulating means.

60. The method as recited in claim 57, in order to control the supply of heat, further including the step of measuring temperature values in the immediate vicinity of the side of the component stack oriented toward the component support.
